(19) United States
(12) Patent Application Publication
(10) Pub. No.: US 2006/0133397 A1
(43) Pub. Date: Jun. 22, 2006

(54) Methods, systems, and computer program products for operating a communication network by performing forward error correction and/or interleaving based on network layer forwarding information

(76) Inventors: Thomas Arnold Anschutz, Conyers, GA (US); Gary Tennyson, Pelham, AL (US)

Correspondence Address: MYERS BIGEL SIBLEY & SAJOVEC, P.A., P.O. BOX 37428, RALEIGH, NC, 27627, US

(21) Appl. No.: 11/021,183

(22) Filed: Dec. 22, 2004

(51) Int. Cl. H04L 12/56; H04J 3/04

(52) U.S. Cl. 370/412; 370/535

(57) ABSTRACT

A communication network is operated by performing forward error correction (FEC) and/or interleaving of frames associated with a plurality of different network forwarding classes based on forwarding information associated with a network layer of an Open Systems Interconnection (OSI) protocol model. The frames are forwarded on a common data link layer of the OSI protocol model.

### FIELD OF THE INVENTION

The present invention relates to communication networks, and, more particularly, to methods, systems, and computer program products for supporting dynamic forward error correction (FEC) and/or interleaving in communication networks.

### BACKGROUND OF THE INVENTION

Digital subscriber line (DSL) and other communication network transport technologies allow for use of forward error correction (FEC) and interleaving techniques to improve bit error rates (BER) in exchange for increased latency and reduced bandwidth. For example FEC techniques typically involve the practice of adding redundancy to a digital transmission to enable transmission errors to be detected and corrected at the receiver. Commonly used types of forward error correction codes include trellis codes, convolutional codes, and Reed Solomon codes. Thus, FEC codes may add overhead to a digital transmission thereby consuming some bandwidth that would otherwise be available for transmission of a data payload. Interleaving refers to the practice of transmitting the data associated with a frame across several frames. Thus, each transmitted frame includes portions of data from several logical frames. By mixing the data up in this manner, impulse noise that may otherwise affect several bits in a row across a single frame will instead corrupt a few bits spread across many frames. It is generally easier to correct the errors when the corrupted bits are not grouped together. Unfortunately, interleaving may increase the latency in a communication network because a receiver typically waits until many frames are received before it can begin processing the frames to correct any errors and deinterleave the data to reassemble the logical frames.

Traditionally, FEC and interleaving parameters are set to a single set of values. For example, referring now to FIG. 1, functional elements of a conventional DSL communications device 100 are shown in which several network transport protocol modules, including a plain old telephone service (POTS) protocol module 105, integrated services digital network (ISDN) protocol module 110, E1/T1 protocol module 115, optical carrier (OC), i.e., synchronous optical network (SONET) protocol module 120, asynchronous transfer mode (ATM) protocol module 125, and Internet Protocol, e.g., point-to-point protocol module 130, are coupled to a multiplexer module 135. The multiplexer 135 multiplexes frames from the various network layer protocols into a transport layer protocol responsive to a synch signal. The frames may then be processed at the transport layer using a scrambler 140, a FEC module 145, and/or an interleaver module 150 where they may then be provided to a core modem 155 for transmission into a core of the communication network. The FEC module 145 and the interleaver module 150 use the same FEC parameters and interleave parameters, respectively, for all network layer protocols. This set of parameters may not be optimal, however, for all network layer protocols. For example, some applications, such as voice, may place higher emphasis on bandwidth and/or low latency and may be tolerant of more errors than would a data application.

This problem may be addressed through the use of the multiple bearer capability of DSL. Referring now to FIG. 2, a conventional network 200 includes the same network layer protocols as illustrated in FIG. 1. Rather than multiplexing all network layer frames onto a single transport layer bearer, two multiplexers 205 and 210 may be used to multiplex some network layer frames onto one DSL bearer and other network layer frames onto another DSL bearer. As shown in FIG. 2, the POTS 105 and ISDN 110 network layer frames are multiplexed onto a first DSL bearer where they are processed by a scrambler module 215 at the transport layer. Because the POTS 105 and ISDN 110 frames are carrying voice, there is no need to perform FEC and/or interleaving in the transport layer. The remaining network layer protocols, however, are multiplexed onto a second DSL bearer where they are processed by a scrambler module 220, a FEC module 225, and an interleaver 230. Thus, those network layer frames that carry data may be multiplexed onto the second DSL bearer where FEC and interleaving may be applied at the transport layer. The transport layer frames may then be multiplexed using the multiplexer 235 to the core modem 240 responsive to a synchronization signal. While the architecture of FIG. 2 may allow for different FEC and/or interleave treatment for different network layer frames, the architecture also involves the use of multiple logical links at the transport layer corresponding to the multiple bearers, reduced maximum bit rates for each logical link (i.e., bearer), increased latency for each logical link on which interleaving is applied, and statically divided (or fragmented) bandwidth among the logical links/bearers.

### SUMMARY OF THE INVENTION

According to some embodiments of the present invention, a communication network is operated by performing forward error correction (FEC) and/or interleaving of frames associated with a plurality of different network forwarding classes based on forwarding information associated with a network layer of an Open Systems Interconnection (OSI) protocol model. The frames are forwarded on a common data link layer of the OSI protocol model.

In other embodiments of the present invention, the frames are multiplexed onto a single bearer at the transport layer.

In still other embodiments of the present invention, the bearer is a digital subscriber line (DSL) bearer.

In still other embodiments of the present invention, a plurality of buffers is provided that are associated with a network layer protocol. Frames are assigned to the plurality of buffers and FEC, interleaving, both FEC and interleaving, or neither FEC nor interleaving are performed on the frames at the network layer based on which buffer each frame is assigned to.

In still other embodiments of the present invention, frames are statistically multiplexed from the plurality of buffers into the transport layer.

In still other embodiments of the present invention, the network layer protocol is the Internet Protocol (IP) and assigning the frames to the plurality of buffers comprises assigning the frames to respective ones of the plurality of buffers based on diffserve codepoint (DSCP) values associated with the each of the frames.

In still other embodiments of the present invention, the network layer protocol is the asynchronous transfer mode (ATM) protocol and the plurality of buffers is virtual circuit buffers.

In still other embodiments of the present invention, the network layer protocol is the Ethernet protocol and the plurality of buffers is Ethernet 802.1P buffers.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 is a block diagram that illustrates a conventional single link/bearer DSL communication device architecture;

FIG. 2 is a block diagram that illustrates a conventional multiple link/bearer communication network architecture;

FIG. 3 is a block diagram that illustrates a network architecture in which forward error correction (FEC) and/or interleaving are performed based on network layer forwarding information, in accordance with some embodiments of the present invention; and

FIG. 4 is a flowchart that illustrates methods, systems, and computer program products for operating a communication network by performing FEC and/or interleaving based on network layer forwarding information in accordance with some embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures. As used herein, the term “and/or” includes any and all combinations of one or more of the associated listed items.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Embodiments of the present invention are described hereafter in the context of processing a frame or frames. It will be understood that the term “frame” means a unit of information and/or a block of data that may be transmitted electronically as a whole or via segments from one device to another. Accordingly, as used herein, the term “frame” may encompass such terms of art as “packet” and/or “message,” which may also be used to refer to a unit of transmission.

As used herein, the term “protocol” refers to a defined set of rules that govern the exchange of data or information between two or more entities. In addition, a “protocol layer” refers to the hierarchical protocol structure represented by the open systems interconnection (OSI) model developed by the International Organization for Standardization in which layer one corresponds to the physical layer, layer two corresponds to the data link layer, layer three corresponds to the network layer, layer four corresponds to the transport layer, layer five corresponds to the session layer, layer six corresponds to the presentation layer, and layer seven corresponds to the application layer.

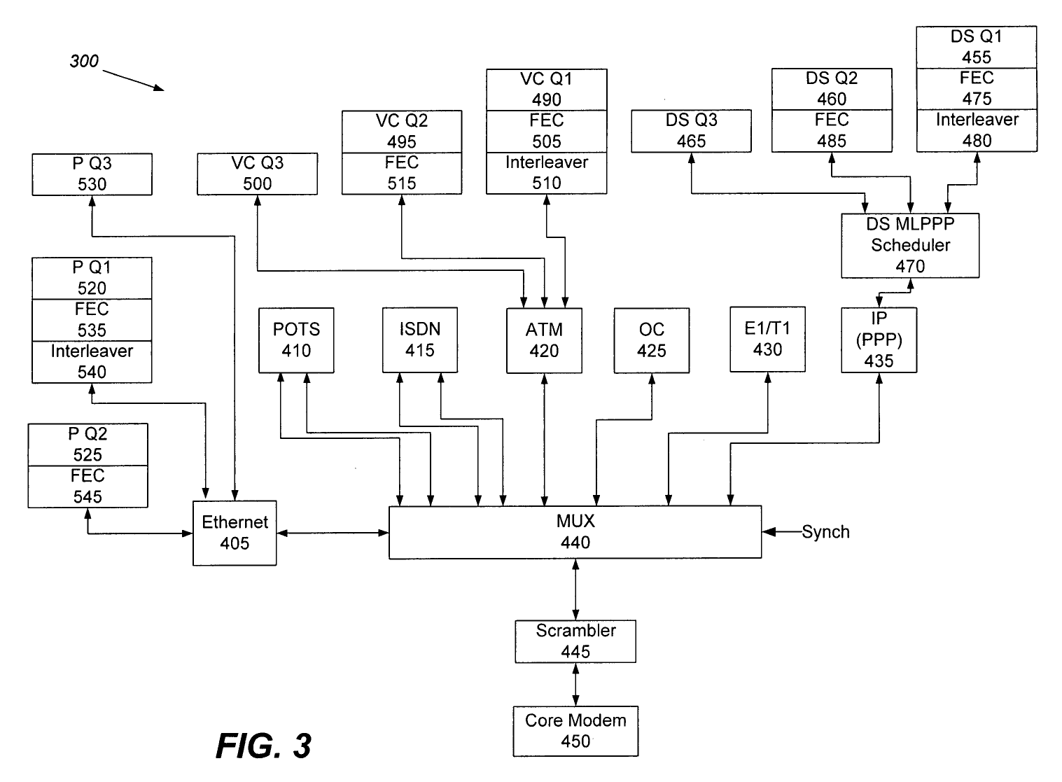

Referring now to FIG. 3, an exemplary communication network architecture 300 in which forward error correction (FEC) and/or interleaving are performed based network layer forwarding information, in accordance with some embodiments of the present invention, will now be described. The communication network comprises several network layer protocol modules, including an Ethernet protocol module 405, plain old telephone service (POTS) protocol module 410, integrated services digital network (ISDN) protocol module 415, asynchronous transfer mode (ATM) protocol module 420, optical carrier (OC), i.e., synchronous optical network (SONET) protocol module 425, E1/T1 protocol module 430, and Internet Protocol, e.g., point-to-point protocol module 435, that are coupled to a multiplexer 440.

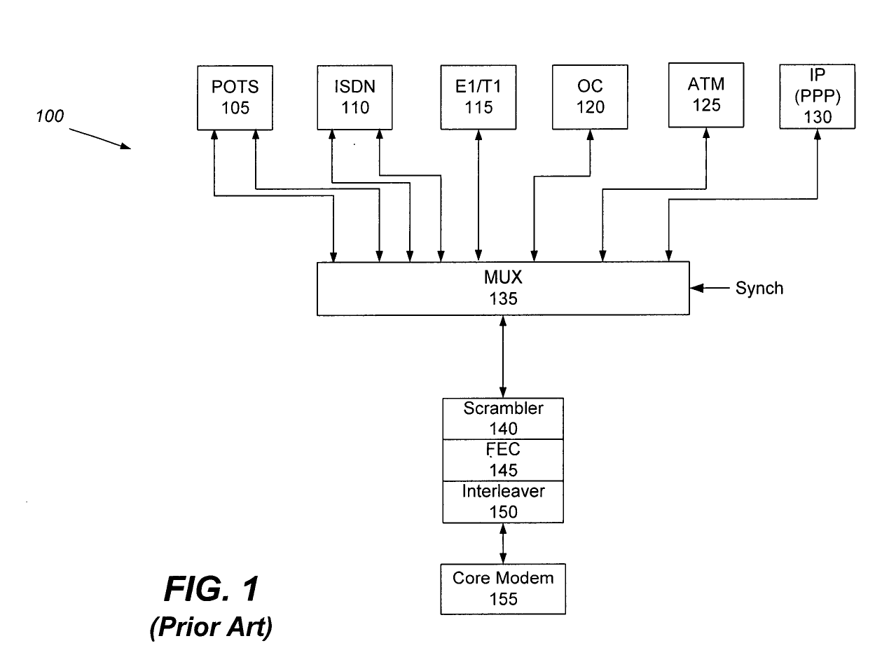

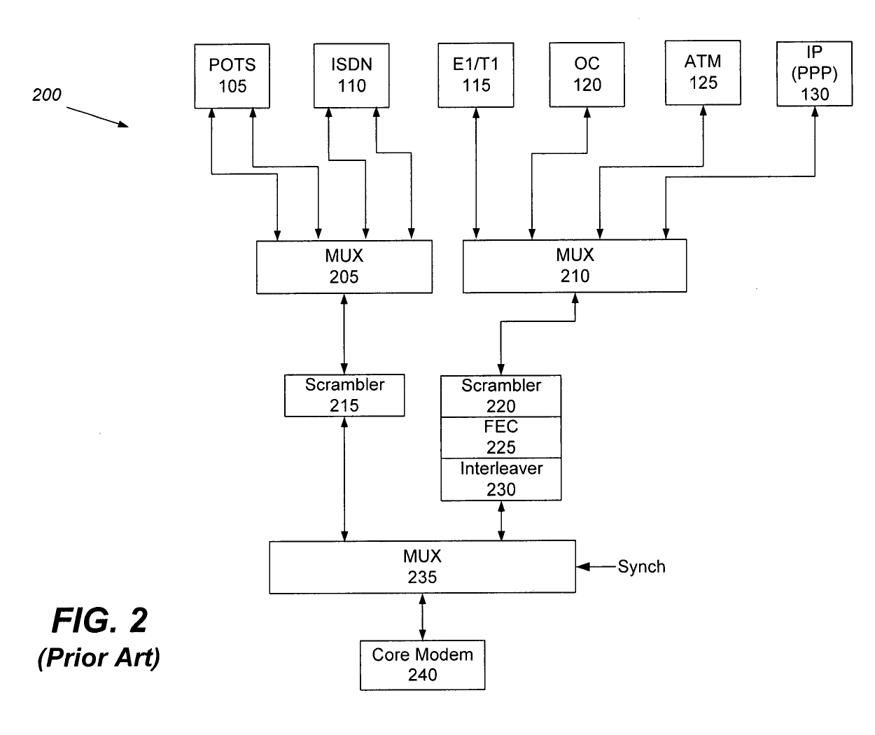

The multiplexer 440 multiplexes frames from the various network layer protocols and/or forwarding classes into a transport layer protocol responsive to a synch signal. The transport layer protocol may be associated with a single DSL bearer in accordance with some embodiments of the present invention. The frames may then be processed at the transport layer using a scrambler 445 where they may then be provided to a core modem 450 for transmission in a DSL or other communication network 400. Thus, in sharp contrast to the architecture of FIG. 1, FEC and/or interleaving are not performed at the transport layer thereby applying the same FEC and/or interleaving treatment to frames associated with all of the different network layer protocols and/or forwarding classes. Moreover, in sharp contrast to the architecture of FIG. 2, multiple transport layer links or bearers are not used thereby statically dividing the bandwidth between the multiple transport layer links/bearers with each link receiving FEC treatment having a reduced bandwidth and each link receiving interleaving treatment having increased latency. Instead, according to some embodiments of the present invention, FEC and/or interleaving are performed based on network layer forwarding information as will be described below.

Referring to FIG. 3, the IP/PPP protocol module 435 has a plurality of differential services buffers and/or queues 455, 460, and 465 that are coupled to the IP/PPP protocol module 435 via a differential services multi-link PPP scheduler module 470. The differential services multi-link PPP scheduler module 470 is a statistical multiplexer that schedules frames from the differential services (diffserve) buffers and/or queues 455, 460, and 465 to the IP/PPP protocol module 435. As shown in FIG. 3, frames stored in the diffserve buffer and/or queue 455 are processed via a FEC module 475 and an interleaver module 480. By contrast, frames stored in the diffserve buffer and/or queue 460 are processed via a FEC module 485. Frames stored in the diffserve buffer and/or queue 465, however, are not processed via a FEC module or an interleaver module. Thus, IP/PPP frames may receive FEC and/or interleaver treatment or neither FEC nor interleaver treatment based on which buffer and/or queue a respective frame is assigned to. The IP/PPP frames may be assigned to a particular diffserve buffer and/or queue based on a differentiated services code point (DSCP) value assigned to an IP/PPP packet.

Similarly, the ATM protocol module 420 has a plurality of virtual circuit buffers and/or queues 490, 495, and 500 that are analogous to the diffserve buffers and/or queues 455, 460, and 465, respectively. That is, frames stored in the virtual circuit buffer and/or queue 490 are processed via a FEC module 505 and an interleaver module 510, frames stored in the virtual circuit buffer and/or queue 495 are processed via a FEC module 515, and frames stored in the virtual circuit buffer and/or queue 500 do not receive FEC or interleaver treatment. The ATM protocol module 420 may include a statistical multiplexer function for scheduling packets from the three virtual circuit buffers and/or queues 490, 495, and 500. Because of the provisioned nature of ATM PVCs, it may be possible to associate various ATM PVCs with the FEC and interleaver functions regardless of the ATM class of service.

The Ethernet protocol module 405 has a plurality of 802.1P buffers and/or queues 520, 525, and 530 that are analogous to the diffserve buffers and/or queues 455, 460, and 465, respectively. That is, frames stored in the 802.1P buffer and/or queue 520 are processed via a FEC module 535 and an interleaver module 540, frames stored in the 802.1P buffer and/or queue 525 are processed via a FEC module 545, and frames stored in the 802.1P buffer and/or queue 530 do not receive FEC or interleaver treatment. The Ethernet protocol module 405 may include a statistical multiplexer function for scheduling packets from the three 802.1P buffers and/or queues 520, 525, and 530.

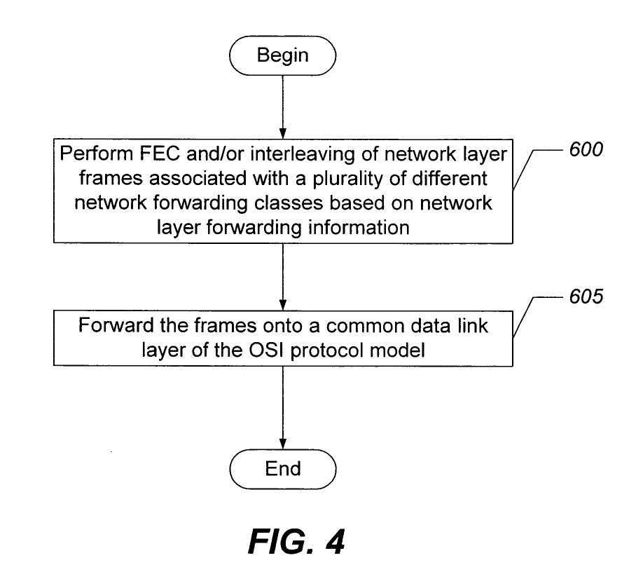

Exemplary operations for operating a communication network by performing FEC and/or interleaving based on network layer forwarding information, in accordance with some embodiments of the present invention, will now be described with reference to FIG. 4. Operations begin at block 600 where FEC and/or interleaving of frames are performed based on forwarding information associated with a network layer of an OSI protocol model. At block 605, the frames are forwarded on a common data link layer of the OSI protocol model. Moreover, the frames associated with various network layer protocols are multiplexed onto a single bearer at a transport layer of the OSI protocol model. Thus, according to some embodiments of the present invention, communication equipment may perform FEC and/or interleaving of frames based on network layer forwarding information, such as packet markings and/or virtual circuit labels, and then forward these frames on a common data link. That is, frames or packets that belong to different network forwarding classes and may, as a result, receive different FEC and/or interleaving treatment, may be forwarded using a shared data link.

Advantageously, frames may be FEC and/or interleaving treatment as appropriate without statically dividing bandwidth in the transport layer and/or adding overhead due to FEC or increasing latency due to interleaving for one or more links/bearers in the transport layer.

The flowchart of FIG. 4 illustrates the architecture, functionality, and operations of some embodiments of methods, systems, and computer program products for operating a communication network by performing FEC and/or interleaving at the network layer, in accordance with some embodiments of the present invention. In this regard, each block represents a module, segment, or portion of code, which comprises one or more executable instructions for implementing the specified logical function(s). It should also be noted that in other implementations, the function(s) noted in the blocks may occur out of the order noted in FIG. 4. For example, two blocks shown in succession may, in fact, be executed substantially concurrently or the blocks may sometimes be executed in the reverse order, depending on the functionality involved.

Many variations and modifications can be made to the embodiments described herein without substantially departing from the principles of the present invention. All such variations and modifications are intended to be included herein within the scope of the present invention, as set forth in the following claims.

That which is claimed:

1. A method of operating a communication network, comprising:
performing forward error correction (FEC) and/or interleaving of frames associated with a plurality of different network forwarding classes based on forwarding information associated with a network layer of an Open Systems Interconnection (OSI) protocol model; and
forwarding the frames on a common data link layer of the OSI protocol model.

2. The method of claim 1, further comprising:
multiplexing the frames onto a single bearer at a transport layer of the OSI protocol model.

3. The method of claim 2, wherein the bearer is a digital subscriber line (DSL) bearer.

4. The method of claim 1, further comprising:
providing a plurality of buffers that are associated with a network layer protocol and/or a network forwarding class;
assigning the frames to the plurality of buffers; and
wherein performing FEC and/or interleaving of frames comprises:
performing FEC and/or interleaving or neither FEC nor interleaving on respective frames at the network layer based on which respective one of the plurality of buffers that each respective frame is assigned to.

5. The method of claim 4, further comprising:
statistically multiplexing frames from the plurality of buffers into the transport layer.

6. The method of claim 4, wherein the network layer protocol is Internet Protocol (IP), and wherein assigning the frames to the plurality of buffers comprises:
assigning respective ones of the frames to respective ones of the plurality of buffers based on respective diffserve codepoint (DSCP) values associated with the respective ones of the frames.

7. The method of claim 4, wherein the network layer protocol is asynchronous transfer mode (ATM), and wherein the plurality of buffers is virtual circuit buffers.

8. The method of claim 4, wherein the network layer protocol is Ethernet, and wherein the plurality of buffers is Ethernet 802.1P buffers.

9. A communication network, comprising:
a network infrastructure that supports an Open Systems Interconnection (OSI) protocol model;
means for performing forward error correction (FEC) and/or interleaving of frames associated with a plurality of different network forwarding classes based on forwarding information associated with a network layer of an Open Systems Interconnection (OSI) protocol model; and
means for forwarding the frames on a common data link layer of the OSI protocol model

10. The communication network of claim 9, further comprising:
means for multiplexing the frames onto a single bearer at a transport layer of the OSI protocol model.

11. The communication network of claim 10, wherein the bearer is a digital subscriber line (DSL) bearer.

12. The communication network of claim 9, further comprising:
a plurality of buffers that are associated with a network layer protocol and/or a network forwarding class;
means for assigning the frames to the plurality of buffers; and
wherein the means for performing FEC and/or interleaving of frames comprises:
means for performing FEC and/or interleaving or neither FEC nor interleaving on respective frames at the network layer based on which respective one of the plurality of buffers that each respective frame is assigned to.

13. The communication network of claim 12, further comprising:
means for statistically multiplexing frames from the plurality of buffers into the transport layer.

14. The communication network of claim 12, wherein the network layer protocol is Internet Protocol (IP), and wherein the means for assigning the frames to the plurality of buffers comprises:
means for assigning respective ones of the frames to respective ones of the plurality of buffers based on respective diffserve codepoint (DSCP) values associated with the respective ones of the frames.

15. The communication network of claim 12, wherein the network layer protocol is asynchronous transfer mode (ATM), and wherein the plurality of buffers is virtual circuit buffers.

16. The communication network of claim 12, wherein the network layer protocol is Ethernet, and wherein the plurality of buffers is Ethernet 802.1P buffers.

17. A computer program for operating a communication network, comprising:
a computer readable storage medium having computer readable program code embodied therein, the computer readable program code comprising:
computer readable program code configured to perform forward error correction (FEC) and/or interleaving of frames associated with a plurality of different network forwarding classes based on forwarding information associated with a network layer of an Open Systems Interconnection (OSI) protocol model; and
computer readable program code configured to forward the frames on a common data link layer of the OSI protocol model.

18. The computer program product of claim 17, further comprising:
computer readable program code configured to multiplex the frames onto a single bearer at a transport layer of the OSI protocol model.

19. The computer program product of claim 17, further comprising:
a plurality of buffers that are associated with a network layer protocol;
computer readable program code configured to assign the frames to the plurality of buffers; and
wherein the computer readable program code configured to perform FEC and/or interleaving of frames comprises:
computer readable program code configured to perform FEC and/or interleaving or neither FEC nor interleaving on respective frames at the network layer based on which respective one of the plurality of buffers that each respective frame is assigned to.

20. The communication network of claim 17, further comprising:
computer readable program code configured to statistically multiplex frames from the plurality of buffers into the transport layer.
